(19) United States
(12) Patent Application Publication
(10) Pub. No.: US 2013/0238459 A1
(43) Pub. Date: Sep. 12, 2013

(54) SYSTEMS AND METHODS FOR AUTOMATIC TICKETING

(71) Applicants: Asim Pasha, Liberty, MO (US); Kyle Lewis Rogers, Kansas City, MO (US); Christopher Robb Heineman, Kansas City, MO (US)

(72) Inventors: Asim Pasha, Liberty, MO (US); Kyle Lewis Rogers, Kansas City, MO (US); Christopher Robb Heineman, Kansas City, MO (US)

(73) Assignee: SPORTING INNOVATIONS, LLC, Kansas City, MO (US)

(21) Appl. No.: 13/416,969

(22) Filed: Mar. 9, 2012

(51) Int. Cl. G06Q 30/00

(52) U.S. Cl. 705/26.1

(57) ABSTRACT

Systems and methods for automatically providing event tickets are provided herein. For example, a device, such as a processor, may execute an automatic ticketing application that associates and/or otherwise provides one or more tickets for an event to a validated membership account. Data associated with a particular membership account and a particular ticketed event is acquired, stored, and/or processed. Subsequently, one or more tickets for the particular ticketed event are automatically associated with a membership account.

### TECHNICAL FIELD

Aspects of the present disclosure relate to electronic ticketing, and in particular, to electronic ticketing using mobile devices.

### BACKGROUND

Concerts, sporting events, and other entertainment events often require attendees to present a ticket to gain access. Historically, in order to obtain access to a ticketed event an individual was required to present a paper or physical ticket. To receive the tickets, individuals would generally have to obtain the physical ticket at the ticketed event venue, ticket box offices, or various retail outlets. Obtaining tickets in such a manner could be a time consuming and frustrating experience. Tickets have also been purchased using the telephone, whereupon a ticket agent assists the purchaser in buying the tickets and then mails the tickets to the purchaser's desired address. Unfortunately, using such physical tickets presented many challenges since the tickets were often lost, stolen, or damaged.

Moreover, as computing devices have become more common place, individuals have begun to purchase tickets electronically, such as via the Internet. However, purchasing tickets using the Internet typically requires an individual to go through a timely registration and purchasing process.

### SUMMARY

Aspects of the present disclosure also include methods for electronic ticketing. The method includes receiving a ticket request, at at least one processor, the ticket request comprising a particular event code, membership identification data, and an originating address on a communication network for the ticket request. The method also includes processing, at the at least one processor, the ticket request to: determine if the ticket request comprises valid membership identification data, the valid membership identification data identifying a particular membership account and identify the particular event code. The method further includes generating, at the at least one processor, a query to search the plurality of event records, wherein each of the event records comprises event data identifying an event, a corresponding event code, a corresponding number of available tickets for the event. The method includes comparing, at the at least one processor, the particular event code to the event data comprised in each event record to: identify the corresponding event code that matches the particular event code and identify the corresponding number of available tickets for the particular event. The method includes assigning, at the at least one processor, a ticket identifier to the particular membership account. The method further includes transmitting, at the at least one processor, a ticket notification comprising the ticket identifier to the originating address on the communication network.

Aspects of the present disclosure include systems for electronic ticketing. The system includes at least one data source comprising event records. The event records comprise a plurality of event records and a plurality member profile records. The system further includes at least one processor encoded with a plurality of instructions. The at least one processor executes the plurality of instructions to receive a ticket request at the at least one processor, the ticket request comprising a particular event code, membership identification data, and an originating address on a messaging network for the ticket request. The at least one processor executes the instructions to process the ticket request to: determine if the ticket request comprises valid membership identification data, the valid membership identification data identifying a particular membership account and identify the particular event code. The at least one processor executes the instructions to: generate a query to search the plurality of event records, wherein each of the event records comprises event data identifying an event, a corresponding event code, a corresponding number of available tickets for the event. The at least one processor executes the instructions to: compare the particular event code to the event data comprised in each event record to: identify the corresponding event code that matches the particular event code and identify the corresponding number of available tickets for the particular event. The at least one processor executes the instructions to: assign a ticket identifier to the particular membership account; and transmit a ticket notification comprising the ticket identifier to the originating address on the messaging network.

Aspects of the present disclosure include a non-transitory computer readable medium for electronic ticketing. The non-transitory computer readable medium is encoded with a ticket application comprising a plurality of instructions executable by a processor. The instructions include an instruction to receive a ticket request at the at least one processor, the ticket request comprising a particular event code, membership identification data, and an originating address on a messaging network for the ticket request. The instructions include an instruction to process the ticket request to: determine if the ticket request comprises valid membership identification data, the valid membership identification data identifying a particular membership account; and identify the particular event code. The instructions further include an instruction to generate a query to search the plurality of event records, wherein each of the event records comprises event data identifying an event, a corresponding event code, a corresponding number of available tickets for the event. The instructions include an instruction to compare the particular event code to the event data comprised in each event record to: identify the corresponding event code that matches the particular event code and identify the corresponding number of available tickets for the particular event. The instructions include an instruction to assign a ticket identifier to the particular membership account and transmit a ticket notification comprising the ticket identifier to the originating address on the messaging network.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. It should be noted that the drawings are not necessarily to scale; however, the emphasis instead is being placed on illustrating the principles of the inventive concepts. Also, in the drawings the like reference characters refer to the same parts throughout the different views. The drawings depict only typical embodiments of the present disclosure and, therefore, are not to be considered limiting in scope.

FIG. 1A is a block diagram illustrating a computing environment for performing automatic ticketing, according to aspects of an automatic ticketing system.

FIG. 1B is a block diagram illustrating a data source, according to aspects of the automatic ticketing system.

FIG. 1C is a block diagram illustrating a client device, according to aspects of the automatic ticketing system.

FIG. 1D is a block diagram illustrating another computing environment for performing automatic ticketing, according to aspects of the automatic ticketing system.

FIG. 1E is a block diagram illustrating a messaging application, according to aspects of the automatic ticketing system.

FIG. 2 is a block diagram illustrating an automatic ticketing system, according to aspects of the automatic ticketing system.

FIG. 3 is a flowchart illustrating an example process for automatically associating one or more tickets with a valid membership profile, according to aspects of the automatic ticketing system.

FIG. 4 is a block diagram illustrating a data input form according to aspects of the automatic ticketing system.

FIG. 5 is another flowchart illustrating an example process for automatically associating one or more tickets with a valid membership profile, according to aspects of the automatic ticketing system.

### DETAILED DESCRIPTION

Aspects of the present disclosure describe systems and corresponding methods for automatically associating, offering, and/or otherwise providing one or more tickets to a valid membership account. An automatic ticketing system receives event data and membership profile data. The automatic ticketing system analyzes the membership profile data to identify a valid membership account. Subsequently, the automatic ticketing system may analyze the event data to identify a particular ticketed event for which the valid membership account desires tickets. The automatic ticketing system determines whether one or more tickets are available for the identified ticketed event, and associates and/or otherwise provides the tickets to the valid membership account.

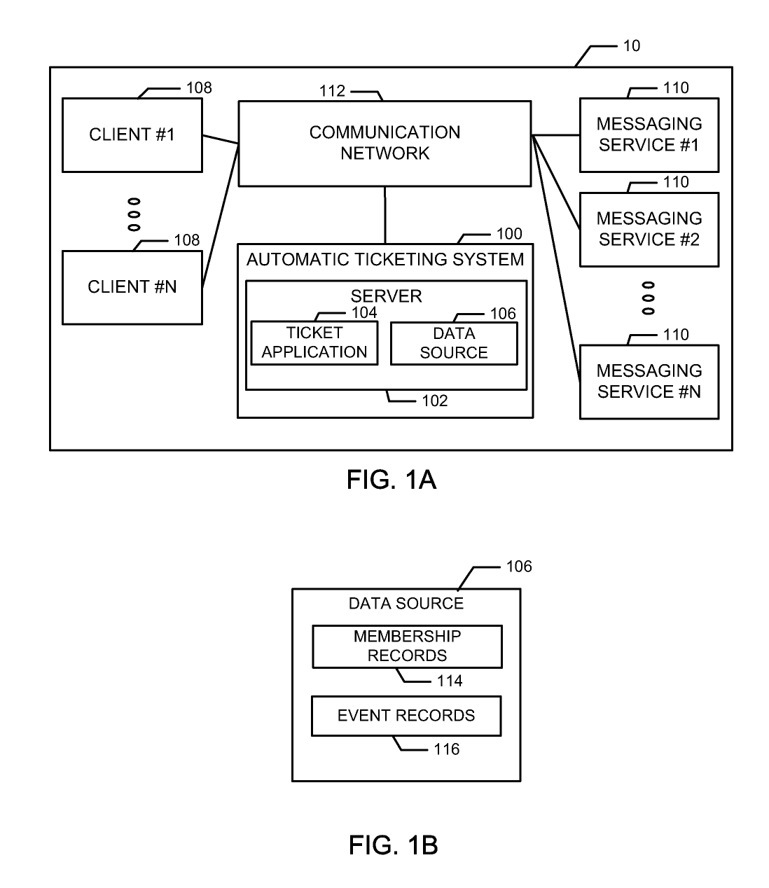

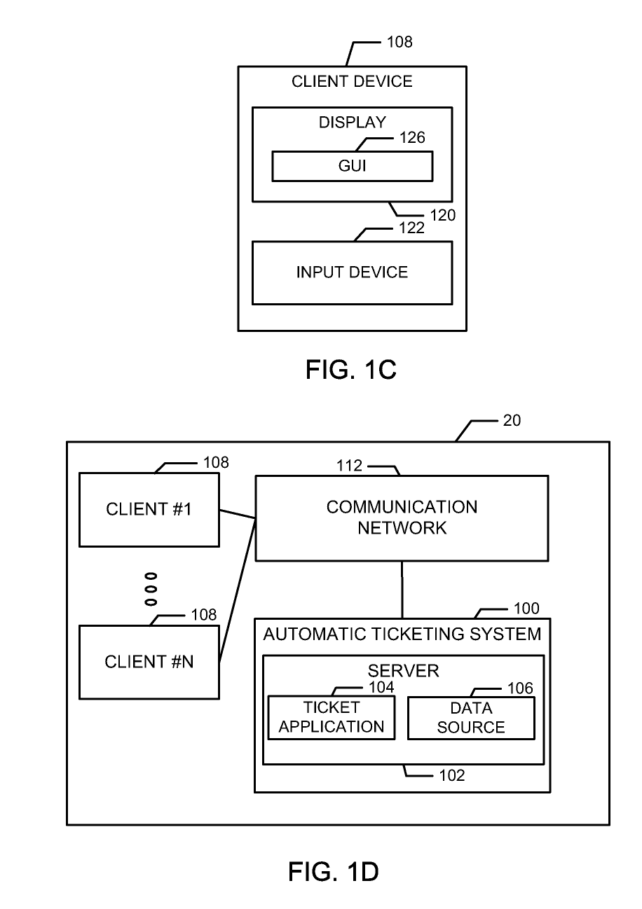

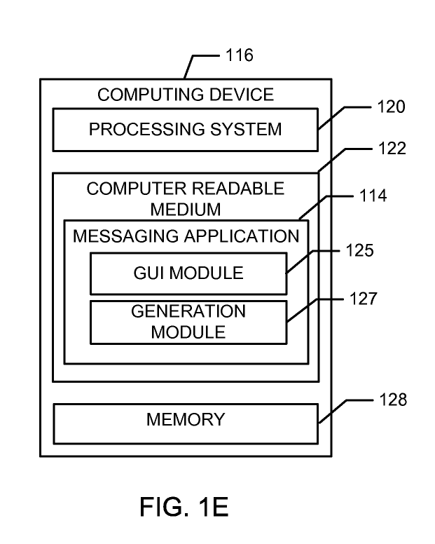

FIG. 1A depicts an exemplary computing environment 10 that my implement the various aspects of the present disclosure. The computing environment 10 includes an automatic ticketing system (“ATS”) 100 that includes a server 102. The server 102 includes a ticket application (“ATA”) 104 and a data source 106. The ATS 100 is linked to one or more client devices (e.g., clients #1-#N) 108 and is further linked to one or more messaging service devices (e.g., messaging services device #1-#N) 110 via a communication network 112. Although the data source 106 is shown as being located on, at, or within the server 102, it is contemplated that the data source 106 may be located remotely from the server 102, such as on, at, or within a database of another computing device or system having at least one processor and volatile and/or non-volatile memory.

The server 102 is a computer and/or computing device that includes one or more processors and memory and executes the ATA 104 to manage the storage of ticket data, event record data, and/or membership data in the data source 106 and to associate one or more tickets with a valid membership profile at the one or more client devices 108. The server 102 is configured to receive data from, and/or transmit data to, the one or more clients 108 through the communication network 112. The server 102 is also configured to receive data from, and/or transmit data to, the one or more remote messaging service devices 110 through the communication network 112. Although the ATS 100 is depicted as including a single server 102, it is contemplated that the ATS 100 may include multiple servers. For example, the ATS 100 may include multiple computer systems in a cloud computing configuration.

The one or more messaging service devices 110 may include one or more processors and memory and may be configured to receive and/or transmit data or other communications to and from the server 102 via the communication network 112. Additionally, the messaging service devices 110 may receive and transmit data or other communications to and from the client devices 108 via the communication network 112 or other messaging network. The messaging service devices 110 may include software and/or hardware components for communicating messages, including but not limited to, a messaging infrastructure (e.g. a short message service center), SMS aggregators and/or SMS gateways, messaging gateways, mobile switching centers, etc. Such hardware and/or software components may provide connections to and/or be associated with messaging communication services, such as AOL instant messenger, Skype, ICQ, GoogleTalk, Twitter, Facebook, etc.

The communication network 112 can be the Internet, an intranet, or another wired or wireless communication network. For example, communication network 112 may include a Mobile Communications (GSM) network, a code division multiple access (CDMA) network, 3rd Generation Partnership Project (3GPP), an Internet Protocol (IP) network, a Wireless Application Protocol (WAP) network, a WiFi network, or an IEEE 802.11 standards network, as well as various combinations thereof. Other conventional and/or later developed wired and wireless networks may also be used.

FIG. 1B illustrates an example embodiment of a data source 106 according to one aspect of the ATS 100. The data source 106 stores membership records 114 and event records 116. Each membership record 114 includes membership profile data that identifies a valid membership associated with the ATS 100. A member may be any entity or individual that is a part of, or otherwise associated with, a particular institution, organization, or club. For example, a member may be an individual associated with a sport franchise fan club. Example membership profile data may include the name of a business, person, account number, an email address, a phone number, a mailing address, authentication information (e.g., user identification code and/or a password.) and/or any other information that may uniquely identify a particular membership associated with the particular organization.

Each event record 116 includes event data that identifies a particular ticketed event, for which one or more tickets may be available. For example, the event data may include data describing the name of the event, time and date information for the event, the geographic location of the event, data indicating the cost of a ticket for the event, serial numbers and/or event code numbers, corresponding ticket data, such as the number of available tickets for the event, and/or other information. It is contemplated that any type of data that may be used to uniquely identify a particular event may be stored as an event record in the data source 106. Although the ATS 100 is depicted as including a single data source 106, it is contemplated that the ATS 100 may include multiple data sources and/or be linked to one or more data sources.

FIG. 1C depicts an exemplary embodiment of the one or more client devices 108 according to one aspect of the ATS 100. The one or more client devices 108 is a computer and/or computing device, mobile device, mobile processor, PDA, tablet computer, etc., that includes one or more processors and memory and is configured to receive data and/or communications from, and/or transmit data and/or communications to the server 102 via the communication network 112. For example, the one or more client devices 108 can be a laptop computer, a personal digital assistant, a tablet computer, standard personal computer, mobile telecommunication device, mobile phone, or another processing device. The client devices 108 include a display 120, such as a computer monitor, for displaying data and/or graphical user interfaces. The client devices 108 may also include an input device 122, such as a keyboard or a pointing device (e.g., a mouse, trackball, pen, or touch screen) to enter data into or interact with graphical user interfaces. Each client device 108 may also include a graphical user interface (or GUI) application 124, such as a browser application, to generate a graphical user interface 126 on the display 120.

A user, such as an authorized member, that desires to obtain a ticket for a particular event, uses the graphical user interface 126 of the one or more client devices 108 to generate a ticket request. For example, a user, desiring to acquire tickets for a sporting event, such as a soccer match, uses the graphical user interface 126 to enter event data and membership profile data. The event data describes the particular soccer match the user wants tickets for and the membership data identifies the user's authorized membership account for which the tickets may be obtained. After entering the event data and membership profile data, a ticket request is generated.

According to one aspect, the ticket request may conform to the format of a particular messaging service. For example, the ticket request may conform to the “Twitter” messaging service and be in the format of a short message of 140 characters or less surrounded and/or embedded with particular characters known as a “tweet.” The ticket request includes the membership data and ticket data and is transmitted to the corresponding message services devices 110. Accordingly, if a tweet were generated as a ticket request, the request would be transmitted to the “Twitter” messaging service. Subsequently, the message services devices 110 transmits the ticket request to the ATS 100. While, the above example uses Twitter, it is contemplated that the ticket request may conform to specific messaging formats other than twitter.

FIG. 1D illustrates another example computing environment 20 that may implement various aspects of the present disclosure. In this example, the computing environment includes one or more client devices 108D, a communication network 112D, and an ATS 100D, all of which operate similarly to the one or more client devices 108, communication network 112, and the ATS 100 described above in connection with FIG. 1A. As can be seen in FIG. 1D, the one or more client devices 108 communicate a ticket request directly to the ATS 100 via the communication network 112 and not through an intermediary messaging service, such as provided by the messaging service device 110 depicted in FIG. 1A.

Rather, in this embodiment, a user uses the graphical user interface 126 of the one or more client devices 108B to generate a ticket request. For example, the client device 108 may generate a ticket request. After entering the event data and membership profile data, a ticket request is generated. The ticket request includes the membership profile data and the ticket data and is transmitted directly to the ATS 100 via the communication network 112.

FIG. 1E is a block diagram depicting an exemplary messaging application 114 executing on a computing device 116 (e.g., client device 108). According to one aspect, the computing device 116 includes a processing system 120 that includes one or more processors or other processing devices. The processing system 120 executes the messaging application 114 to automatically generate a ticket request for a particular member requesting one or more tickets to a particular event. The processing system 120 may include memory and/or be in communication with a memory 128, which may include volatile and/or non-volatile memory.

According to one aspect, the computing device 116 includes a computer readable medium (“CRM”) 122 configured with the messaging application 114. The messaging application 114 includes instructions to automatically generate a ticket request for a particular member requesting one or more tickets to a particular event.

The CRM 122 may include volatile media, nonvolatile media, removable media, non-removable media, and/or another available medium that can be accessed by the computing device 116. By way of example and not limitation, computer readable medium 122 comprises computer storage media and communication media. Computer storage media includes nontransient memory, volatile media, nonvolatile media, removable media, and/or non-removable media implemented in a method or technology for storage of information, such as computer readable instructions, data structures, program modules, or other data. Communication media may embody computer readable instructions, data structures, program modules, or other data and include an information delivery media or system. In one particular implementation, the CRM 122 may store executable instructions and/or program modules that implement the messaging application 114. Generally, program modules include routines, programs, instructions, objects, components, data structures, etc., that perform particular tasks or implement particular abstract data types.

A GUI module 125 may receive membership profile data and/or event data from the one or more client devices 108. The GUI module 125 may transmit instructions that may be processed and/or executed to display one or more input forms 400 on the client devices 108 to receive membership profile data and event data. Subsequently, a user, such a member, may interact with the one or more input forms to enter membership profile data and event data identifying the user as a valid member, and describing a particular event for which the member desires tickets. FIG. 4 is an illustrative example of an input form 400 for entering membership profile data and event data. A user may enter membership profile data, such as membership number at 402, event data, such as a description of the event for which the member desires tickets at 404, and a specific number of tickets desired at 406. Other membership profile data and event data may be included.

A generation module 126 may process and/or otherwise parse the membership identification data and event data received by the GUI module 125 to generate one or more ticket requests in a particular format corresponding to one of the one or more messaging services 110. For example, in one particular implementation, when the messaging service is “Twitter,” the generation module 126 may generate a ticket request in the format known as a “tweet.” Specifically, the generation module 126 may process the received membership profile data and/or the event data to generate a tweet embedded with one or more discrete parameters. For example, the parameters may include an “MN” parameter, a “date” parameter, and a “Numticks” parameter. The “MN” parameter represents the membership number of a particular member requesting tickets. Accordingly, the generation module 126 may process the membership profile data to extract a membership number and assign the membership number to the “MN” parameter. The “Event” parameter provides an indication of a particular event and the time at which the particular event may take place, such as the time, date, and/or location. Thus, the generation module 126 may process the event data to extract a particular event and corresponding event time and assign the particular event and corresponding event time to the “Event” parameter. The “Numticks” parameter indicates the number of tickets that a member desires. Accordingly, the generation module 126 may process the event data to extract a specific number of tickets for a particular event a member desires and assign the specific number of tickets to the “Numticks” parameter. Other parameters may also be included. Once the ticket request has been generated, the message is provided to the corresponding messaging service 110. Thus, any tweets generated by the generation module 126 may be provided to the Twitter messaging service. While the above example illustrates the generation of a ticket request in the format corresponding to a Twitter messaging service, it is contemplated that a ticket request may be generated in a format corresponding to any type if messaging service.

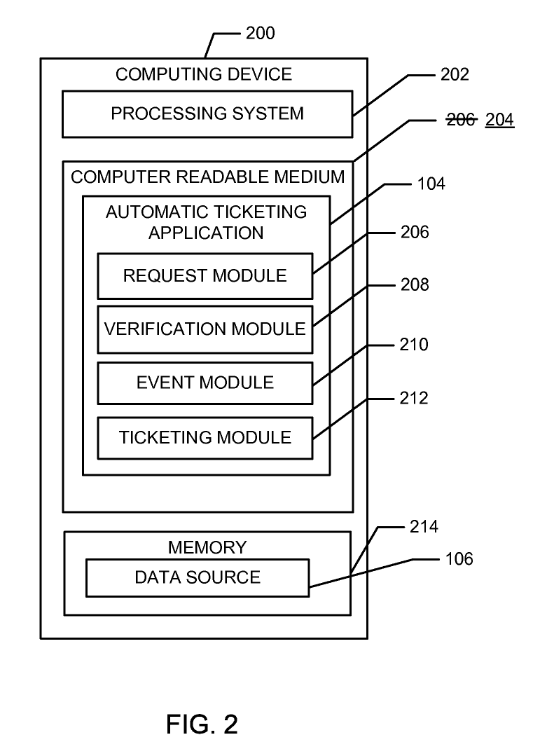

FIG. 2 is a block diagram depicting an exemplary ATA 104 executing on a computing device 200 (e.g., server 102). According to one aspect, the computing device 300 includes a processing system 202 that includes one or more processors or other processing devices. The processing system 202 executes an exemplary ATA 104 to automatically associate and/or otherwise provide one or more tickets with and/or to an identified membership. The processing system 202may include memory and/or be in communication with a memory 214, which may include volatile and/or non-volatile memory.

According to one aspect, the computing device 200 includes a computer readable medium (“CRM”) 204 configured with the ATA 104. The ATA 104 includes instructions to automatically associate and/or otherwise provide one or more tickets with and/or to an identified membership.

The CRM 204 may include volatile media, nonvolatile media, removable media, non-removable media, and/or another available medium that can be accessed by the computing device 200. By way of example and not limitation, computer readable medium 204 comprises computer storage media and communication media. Computer storage media includes nontransient memory, volatile media, nonvolatile media, removable media, and/or non-removable media implemented in a method or technology for storage of information, such as computer readable instructions, data structures, program modules, or other data. Communication media may embody computer readable instructions, data structures, program modules, or other data and include an information delivery media or system. In one particular implementation, the CRM 204 may store executable instructions and/or program modules that implement the ticket application 104. Generally, program modules include routines, programs, instructions, objects, components, data structures, etc., that perform particular tasks or implement particular abstract data types.

A request module 206 receives one or more ticket requests from the client devices 108 and/or generated by the generation module 205. The request module 206 analyzes, parses, and/or otherwise processes the ticket request to identify membership profile data and event data. For example, the request module 206 may process the ticket request to identify a unique membership ID and an event identification code. The request module 306 also generates an event query including the event data in response to the one or more ticket requests.

In one particular implementation, the ticket request may be received by the request module 306 in a particular format from the one or more messaging services 110. The format may be in the format of the particular messaging services. For example, when the messaging services is “Twitter,” the ticket request may be in the format of a “tweet,” or a short message of 140 characters or less embedded with one or more parameters. The request module 306 analyzes, parses, and/or otherwise processes the “tweet” ticket request to identify membership profile data and event data.

A verification module 208 processes the membership profile data identified by the request module 206 to determine whether a valid member exists, and/or whether a user is associated with a valid membership account. The verification module 208 may compare the membership profile data to one or more membership records in the data source 106 to determine whether a valid membership exists. For example, the verification module 208 may match a unique membership ID number provided in membership profile data included in the ticket request to a membership ID for a particular membership profile record stored in the data source 106. When a membership ID is matched with the received membership profile data, the verification module 208 indicates and/or otherwise provides a verification response specifying that the member has been identified.

Once a valid membership has been identified, an event module 210 processes the event query generated by the receiving module 206 to identify a particular event for which the valid member wants one or more tickets. The event module 210 searches the data source 106 to identify an event record that includes event data matching the identified event data. For example, if event data including an event name and corresponding event code included in the event query matches an event name and corresponding event code in the event data of a particular event record, the event module generates an event response that includes the matching event record. After a particular event has been identified, the event module 210 may identify a corresponding number of available tickets for the particular event by searching or otherwise parsing the event record corresponding to the identified event. For example, if the event module 210 identified a soccer match as the particular event for which a valid member desires tickets, the event module may search the soccer match event record and determine that 200 tickets are available.

A ticketing module 212 may assign a ticket identifier, associated with one of the available tickets identified by the event module 210 to the membership account validated by the verification module 208. The ticket identifier may be any information that uniquely identifies a particular ticket. For example, the ticket identifier may be a serial number, barcode, QR code, e-ticket, etc. The ticketing module 212 may transmit and/or otherwise provide a ticket notification including the ticket identifier to the originating address, such as to one of the client devices 108 for display. In one particular implementation, the ticketing module 212 may provide for display the ticket notification in a format that corresponds to the format in which the original ticket request was received. For example, if a ticket request were received in the format of a “tweet” by the receiving module 206, the ticketing module 212 may generate a ticket notification in the format of a tweet embedded with a ticket identifier, such as a scannable barcode or a QR code.

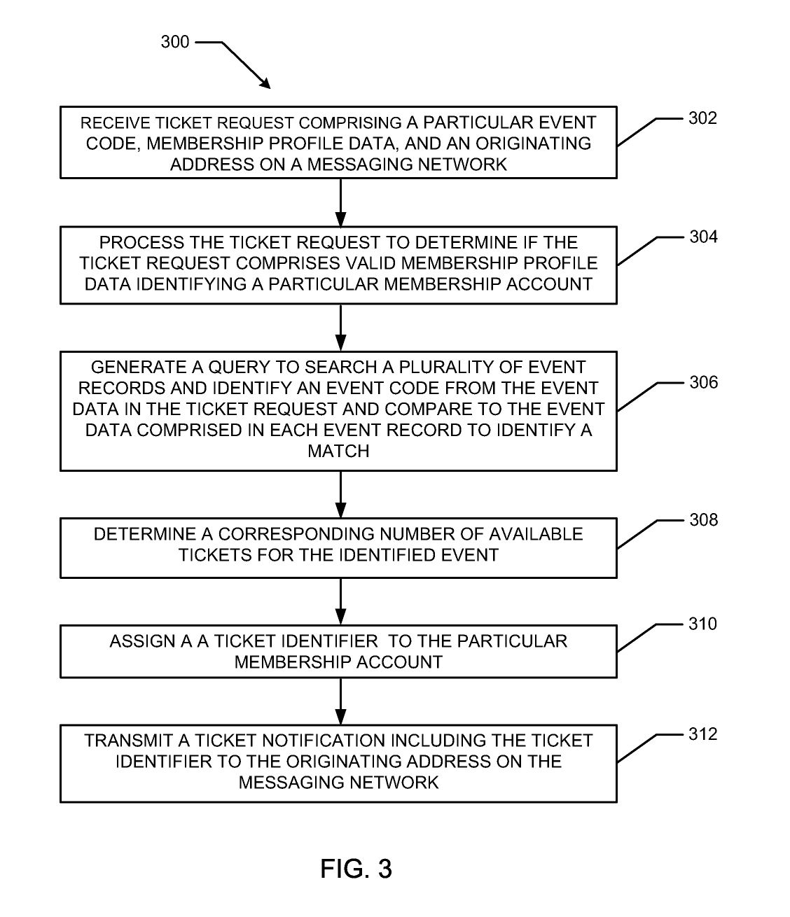

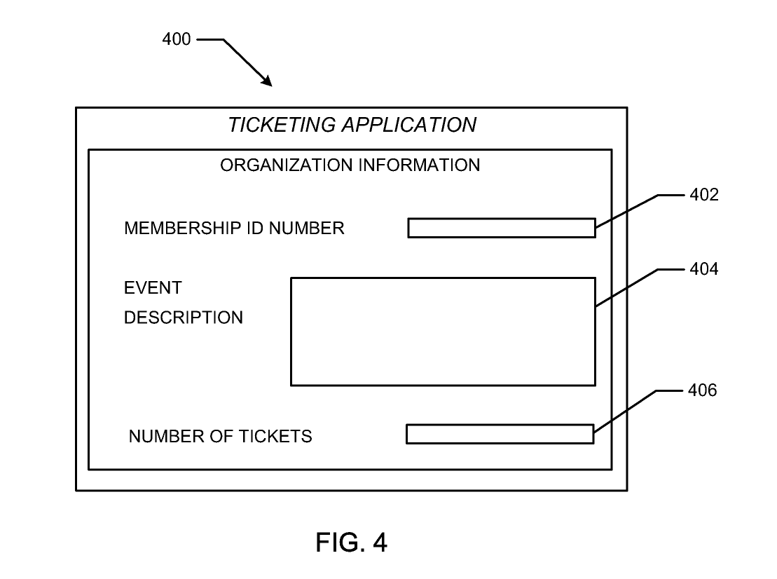

FIG. 3 depicts an example embodiment of a method and/or process 300 for automatically providing and/or associating one or more tickets with a valid membership profile. The process 300 may be executed by at least one processor encoded with, or executing instructions of, the ticket application 104. At 302, a ticket request comprising a particular event code, membership profile data, and an originating address on a messaging network is received. For example, the server 102 receives a ticket request from the messaging services 110. At 304, the ticket request is processed to determine if the ticket request comprises valid membership profile data identifying a particular membership account and event data identifying an event code for a particular event. For example, the ticket request is parsed to extract membership profile data including a member name and corresponding member ID of “Christopher #44543.”

At 306, a query to search a plurality of event records is generated to search a plurality of event codes in the data source 106. An event code is identified from the event data in the ticket request and compared to the event data comprised in each event record to identify a match. For example, a unique event code “1B00554” indicating that the event is a professional soccer match is identified.

At 308, a corresponding number of available tickets are determined for the identified event. Referring to the soccer match example, 50 tickets are identified as being available for valid membership accounts. At 310, a ticket identifier is assigned to the particular membership account. For example, a unique ticket serial numbers is assigned to the valid membership account. At 312, a ticket notification including the ticket identifier is transmitted to the originating address on the messaging network. For example, the notification is transmitted to the client devices 108 for display to a user.

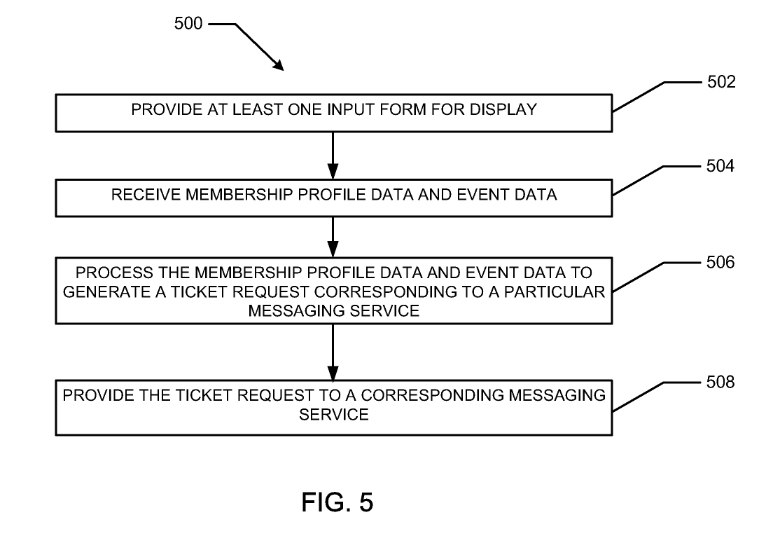

FIG. 5 depicts an example embodiment of a method and/or process 500 for automatically providing and/or associating one or more tickets with a valid membership profile. The process 500 may be executed by at least one processor encoded with, or executing instructions of, the messaging application 114.

At 502, at least one input form is provided for display. For example, an input form such as the form illustrated in FIG. 4 is displayed on a client device 108. Membership profile data and event data is received from a user at a client device 108 at 504. For example, a user, such as a valid member, provides a membership identification number and corresponding event data indicating that the member would like seven tickets to an upcoming soccer match. The membership profile data and event data is processed at 506 to generate a ticket request corresponding to a particular messaging service format. For example, a the membership profile data and event data is processed and embedded as discrete parameters embedded in a “tweet” for the Twitter messaging service. At 508, the ticket request is provided to the corresponding messaging service. For example, the tweet is provided to the Twitter messaging service.

The description above includes example systems, methods, techniques, instruction sequences, and/or computer program products that embody techniques of the present disclosure. However, it is understood that the described disclosure may be practiced without these specific details.

In the present disclosure, the methods disclosed may be implemented as sets of instructions or software readable and executable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

1. A method for electronic ticketing comprising:
receiving a ticket request, at at least one processor, the ticket request comprising a particular event code, membership identification data, and an originating address on a communication network for the ticket request;
processing, at the at least one processor, the ticket request to:
determine if the ticket request comprises valid membership identification data, the valid membership identification data identifying a particular membership account; and
identify the particular event code; and
generating, at the at least one processor, a query to search the plurality of event records, wherein each of the event records comprises event data, identifying an event, a corresponding event code, a corresponding number of available tickets for the event;
comparing, at the at least one processor, the particular event code to the event data comprised in each event record to:
identify the corresponding event code that matches the particular event code; and
identify the corresponding number of available tickets for the particular event;
assigning, at the at least one processor, a ticket identifier to the particular membership account;
determining whether the ticket request is in a first format or a second format,
transmitting, at the at least one processor, a ticket notification in the first format when the ticket request is in the first format; and
transmitting, at the at least one processor, the ticket notification in the second format when the ticket request is in the second format,
wherein the ticket notification comprises the ticket identifier to the originating address on the communication network.

2. The method of claim 1 further comprising comparing the membership identification data to a list of membership identification data to determine if the request comprises valid membership identification data.

3. The method of claim 1 wherein the ticket identifier is selected from the group consisting of a barcode, QR code, serial number, and electronic ticket.

4. The method of claim 1 wherein the ticket request in the first format corresponds to a text message in short messaging service format.

5-19. (canceled)

20. The method of claim 1 wherein the ticket request in the second format corresponds to a tweet.

21. The method of claim 1 wherein processing the ticket request comprises parsing the ticket request to identify a member name and the particular event code.

22. A system for electronic ticketing comprising:
at least one data source comprising event records, the event records comprising:
a plurality of event records; and
a plurality member profile records;
at least one processor encoded with a plurality of instructions, the at least one processor executing the plurality of instructions to:
receive a ticket request at the at least one processor, the ticket request comprising a particular event code, membership identification data, and an originating address on a communication network for the ticket request;
process the ticket request to:
determine if the ticket request comprises valid membership identification data, the valid membership identification data identifying a particular membership account; and
identify the particular event code;
generate a query to search the plurality of event records, wherein each of the event records comprises event data identifying an event, a corresponding event code, a corresponding number of available tickets for the event; and
compare the particular event code to the event data comprised in each event record to:
identify the corresponding event code that matches the particular event code; and
identify the corresponding number of available tickets for the particular event;
assign a ticket identifier to the particular membership account;
determine whether the ticket request is in a first format or a second format,
transmit a ticket notification in the first format when the ticket request is in the first format; and
transmit the ticket notification in the second format when the ticket request is in the second format,
wherein the ticket notification comprises the ticket identifier to the originating address on the communication network.

23. The system of claim 22 wherein the at least one processor executing the plurality of instructions is configured to compare the membership identification data to a list of membership identification data to determine if the request comprises valid membership identification data.

24. The system of claim 22 wherein the ticket identifier is selected from the group consisting of a barcode, QR code, serial number, and electronic ticket.

25. The system of claim 22 wherein the ticket request in the first format corresponds to a text message in short messaging service format.

26. The system of claim 22 wherein the ticket request in the second format corresponds to a tweet.

27. The system of claim 22 wherein the at least one processor executing the plurality of instructions is configured to process the ticket request by parsing the ticket request to identify a member name and the particular event code.

28. A non-transitory computer-readable medium encoded with a ticket application comprising a plurality of instructions executable by a processor to:
receive a ticket request comprising a particular event code, membership identification data, and an originating address on a communication network for the ticket request;
process the ticket request to:
determine if the ticket request comprises valid membership identification data, the valid membership identification data identifying a particular membership account; and
identify the particular event code;
generate a query to search the plurality of event records, wherein each of the event records comprises event data identifying an event, a corresponding event code, a corresponding number of available tickets for the event; and
compare the particular event code to the event data comprised in each event record to:
identify the corresponding event code that matches the particular event code; and
identify the corresponding number of available tickets for the particular event;
assign a ticket identifier to the particular membership account;
determine whether the ticket request is in a first format or a second format, and
transmit a ticket notification in the first format when the ticket request is in the first format; and
transmit the ticket notification in the second format when the ticket request is in the second format,
wherein the ticket notification comprises the ticket identifier to the originating address on the communication network.

29. The non-transitory computer-readable medium of claim 28 wherein the at least one processor executing the plurality of instructions is configured to compare the membership identification data to a list of membership identification data to determine if the request comprises valid membership identification data.

30. The non-transitory computer-readable medium of claim 28 wherein the ticket identifier is selected from the group consisting of a barcode, QR code, serial number, and electronic ticket.

31. The non-transitory computer-readable medium of claim 28 wherein the ticket request in the first format corresponds to a text message in short messaging service format.

32. The non-transitory computer-readable medium of claim 28 wherein the ticket request in the second format corresponds to a tweet.

33. The non-transitory computer-readable medium of claim 28 wherein the at least one processor executing the plurality of instructions is configured to process the ticket request by parsing the ticket request to identify a member name and the particular event code.
